(19) United States
(12) Patent Application Publication
(10) Pub. No.: US 2004/0137153 A1
(43) Pub. Date: Jul. 15, 2004

(54) Layered stacks and methods of production thereof

(76) Inventors: Michael Thomas, Milpitas, CA (US); Brian Daniels, La Honda, CA (US); Paul Apen, San Francisco, CA (US); Ananth Naman, San Jose, CA (US); Nancy Iwamoto, Ramona, CA (US); Boris Korolev, San Jose, CA (US); Bo Li, San Jose, CA (US)

Correspondence Address: Sandra P Thompson, Bingham McCutchen, 18th Floor, 600 Anton Boulevard, Costa Mesa, CA, 92626, US

(21) Appl. No.: 10/466,652

(22) PCT Filed: Apr. 16, 2002
(86) PCT No.: PCT/US02/11927

(51) Int. Cl. B05D 7/00; B32B 9/04

(52) U.S. Cl. 427/384; 427/402; 427/387; 428/58; 427/498; 438/623; 438/624; 428/447; 428/448

(57) ABSTRACT

Low dielectric constant layered materials and a methof for making said layered materials comprising the steps of: a) providing a surface; b) spinning a dielectric material on to the surface; c) curing the dielectric material to form a dielectric layer; d) spinning a low dielectric constant material on to the dielectric layer; and e) curing the low dielectric constant material to form a low dielectric constant layer. Each layer can be spun-on to the layered component and subsequently cured before additional layers are added or all layers can be spun-on to the layered component and then the entire stack is cured at once.

This application is based on U.S. Provisional Application Serial No. 60/284,271 filed on Apr. 16, 2001 and U.S. Provisional Application Serial No. 60/294,864 filed on May 30, 2001, which are both herein incorporated by reference in their entirety.

### FIELD OF THE INVENTION

The field of the invention is semiconductor and electronic materials, components and applications. More specifically, the field of the invention is layered materials and components for semiconductor and electronic applications.

### BACKGROUND

As interconnectivity in integrated circuits increases and the size of functional elements decreases, the dielectric constant of insulator materials and other materials embedding the metallic conductor lines in integrated circuits becomes an increasingly important factor influencing the performance and dielectric abilities of the integrated circuit. Insulator materials having low dielectric constants (i.e., below 3.0) are especially desirable, because they typically allow faster signal propagation, reduce capacitive effects and cross talk between conductor lines, and lower voltages to drive integrated circuits.

One way of achieving low dielectric constants in the insulator material is to employ materials with inherently low dielectric constants. Generally, two different classes of low dielectric constant materials have been employed in recent years—inorganic oxides and organic polymers. Inorganic oxides, which may be applied by chemical vapor deposition or spin-on techniques, have dielectric constants between about 3 and 4, and have been widely used in interconnects with design rule larger than 0.25 μm. However, as the dimension of interconnects continue to shrink, materials with even lower dielectric constant become more desirable.

One problem with incorporating low dielectric constant materials with other materials is that the effective dielectric constant of the component can increase if the dielectric constant of the other materials is measurably higher than that of the low dielectric constant materials. In order to correct this problem, layered components can be constructed wherein each layer or at least more than one layer is designed to have a low dielectric constant. (add references) However, with the added benefit of lowering the effective dielectric constant of the component has come the difficulty of efficiently constructing the components. For example, the dielectric layer may be applied by spinning the dielectric material onto a surface or substrate, and then an additional layer, such as a hardmask layer or etch stop layer, may be applied by a chemical vapor deposition (CVD) process.

Although various methods are known in the art to produce low dielectric constant materials and layered materials, all, or almost all of them have disadvantages when trying to incorporate them into building and assembling layered components and layered stacks. Thus, there is still a need to a) provide improved compositions and methods to lower the dielectric constant of a materials, b) introduce those low dielectric constant materials efficiently onto a surface or substrate, and c) efficiently and cost-effectively build up and/or layer these low dielectric constant materials while keeping the effective dielectric constant low.

### SUMMARY OF THE INVENTION

In order to produce low dielectric constant layered materials that are relatively easy to make and cost efficient, individual layers will be spun-on to either a surface or another layer (or layers) that has (have) been previously spun-on to a surface. Generally, it is desirable that all of the low dielectric constant layers of a particular layered material or layered component be applied by spinning a material or materials on to a surface or substrate. It is further desirable that all of the layers of the component be applied by spinning the materials onto the component, but there may be an additional layer or layers that are applied by other means. For the most part, the low dielectric constant layered component will have at least two low dielectric constant layers that have been spun-on to become part of the component, regardless of any other additional layers or materials that are applied.

Low dielectric constant layered materials and components are described herein that include a) a surface or substrate; b) at least one spin-on dielectric layer coupled to the surface; and c) at least one additional spin-on low dielectric constant layer coupled to the at least one spin-on dielectric layer. A barrier/Cu seed layer can also be added to this all-spin on scheme, along with the copper or metal via fill. The at least one additional spin-on low dielectric constant layer may comprise at least one spin-on stop layer and/or at least one spin-on cap layer. It is further contemplated that the at least one additional spin-on low dielectric constant layer comprises two or more layers or at least two additional spin-on layers.

Methods of producing a low dielectric constant layered component are described that include: a) providing a surface; b) spinning a dielectric material on to the surface; c) curing the dielectric material to form a dielectric layer; d) spinning a low dielectric constant material on to the dielectric layer; and e) curing the low dielectric constant material to form a low dielectric constant layer. Each layer can be spun-on to the layered component and subsequently cured before additional layers are added or all layers can be spun-on to the layered component and then the entire stack is cured at one time.

### BRIEF DESCRIPTION OF THE FIGURES

FIG. 1 shows a prior art configuration of a layered stack/component.

FIG. 2 shows a preferred embodiment of a layered component.

FIG. 3A shows a prior art method of producing a layered stack/component.

FIG. 3B shows a preferred method of producing a layered stack/component.

FIG. 4 shows a graphical depiction of the reproducibility of a TEL ACT 12 Coater.

FIG. 5 shows a schematic depiction of several preferred stacked low-k strategies.

FIG. 6 shows a graphical and table depiction of the keff of two-layer stacks.

FIG. 7 shows a preferred dual damascene setup along with graphical and table information related to the setup.

FIG. 8 shows a schematic of a preferred manufacturing setup.

### DETAILED DESCRIPTION

In order to produce low dielectric constant layered materials that are relatively easy to make and cost efficient, it is contemplated that the individual layers will be spun-on to either a surface or another layer (or layers) that has (have) been previously spun-on to a surface. Generally, it is desirable that all of the low dielectric constant layers of a particular layered material or layered component be applied by spinning a material or materials on to a surface or substrate. It is further desirable that all of the layers of the component be applied by spinning the materials onto the component, but there may be an additional layer or layers that are applied by other means. For the most part, the low dielectric constant layered component will have at least two low dielectric constant layers that have been spun-on to become part of the component, regardless of any other additional layers or materials that are applied. (Michael E. Thomas, “Spin-On Stacked Films for Low k_{eff} Dielectrics”, Solid State Technology (July 2001), incorporated herein in its entirety by reference).

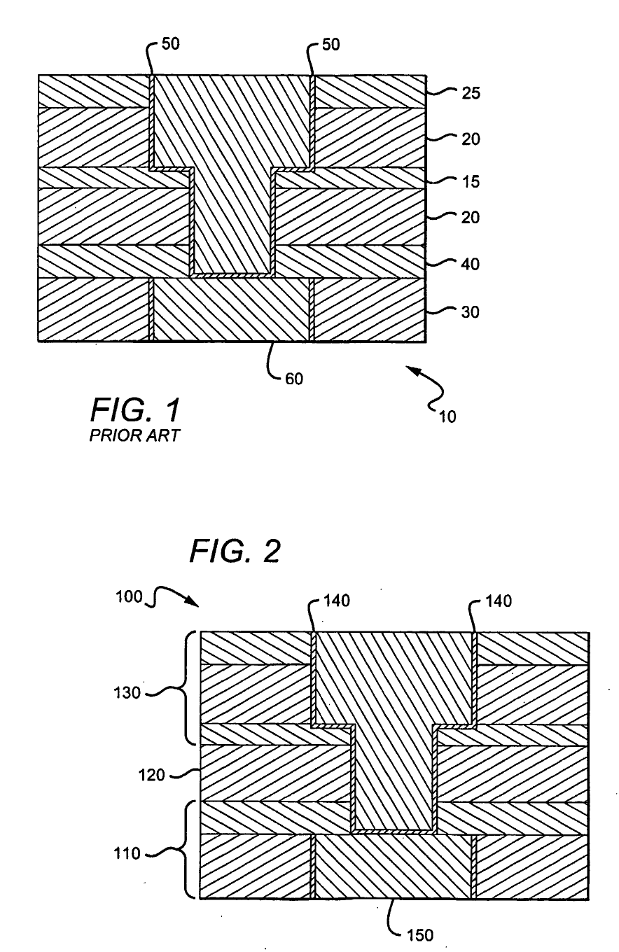

Prior Art FIG. 1 shows a standard interlayer/interline dielectric (ILD) integration scheme (10) that combines chemical vapor deposition (CVD) dielectrics as etch stops (15) and cap layers (25) with spin on low dielectric constant (low-k) dielectric materials (20). The interlayer dielectric (10) is integrated with a dielectric layer (30), a CVD barrier layer (40), a barrier/Cu seed layer (50) and a copper or metal via fill (60). All of these additional components may or may not be applied by spinning them on to a surface.

Low dielectric constant layered materials and components (100) are described herein and shown in FIG. 2 that comprise a) a surface or substrate (110) (shown in FIG. 2 as the Dielectric/CVD barrier combination); b) at least one spin-on dielectric layer coupled to the surface (120); and c) at least one additional spin-on low dielectric constant layer coupled to the at least one spin-on dielectric layer (130). A barrier/Cu seed layer (140) can also be added to this all-spin on scheme, along with the copper or metal via fill (150). The at least one additional spin-on low dielectric constant layer may comprise at least one spin-on stop layer and/or at least one spin-on cap layer. It is further contemplated that the at least one additional spin-on low dielectric constant layer comprises two or more layers or at least two additional spin-on layers.

Surfaces contemplated herein may comprise any desirable substantially solid material, such as a substrate, wafer or other suitable surface. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimide, BT, and FR4. In more preferred embodiments, the substrate comprises a material common in the packaging and circuit board industries such as silicon, copper, glass, and another polymer. Suitable surfaces contemplated herein may also include another previously formed layered stack, other layered component, or other component altogether. An example of this may be where a dielectric material and CVD barrier layer are first laid down as a layered stack—which is considered the “surface” for the subsequently spun-on layered component.

At least one spin-on dielectric layer is coupled to the surface or substrate. As used herein, the term “coupled” means that the surface and layer or two layers are physically attached to one another or there's a physical attraction between two parts of matter or components, including bond forces such as covalent and ionic bonding, and non-bond forces such as Van der Waals, electrostatic, coulombic, hydrogen bonding and/or magnetic attraction. Also, as used herein, the term coupled is meant to encompass a situation where the surface and spin-on layer or two spin-on layers are directly attached to one another, but the term is also meant to encompass the situation where the surface and spin-on layer or two spin-on layers are coupled to one another indirectly—such as the case where there's an adhesion promoter layer between the surface and spin-on layer or where there's another layer altogether between the surface and spin-on layer or two spin-on layers.

The spin-on dielectric layer may comprise any suitable material that meets the following two requirements: a) the dielectric material is capable of being spun-on to a surface or other layer and b) the dielectric material forms a low dielectric constant layer or component after curing or other finishing treatment. As used herein, the term “low dielectric constant” means a dielectric constant of 1 MHz to 2 GHz, unless otherwise inconsistent with context. It is contemplated that the value of the dielectric constant of a low dielectric constant material or layer is less than 3.0. In a preferred embodiment, the value of a low dielectric constant material or layer is less than 2.5. In a more preferred embodiment, the value of a dielectric constant material or layer is less than 2.0.

Contemplated spin-on low dielectric materials comprise inorganic-based compounds, such as silicon-based, gallium-based, germanium-based, arsenic-based, boron-based compounds or combinations thereof, and organic-based compounds, such as polyethers, polyarylene ethers (such as FLARE™—manufactured by Honeywell Electronic Materials), polyimides, polyesters and adamantane-based or cage-based compounds.

As used herein, the phrases “spin-on material”, “spin-on organic material” (where the composition is substantially organic), “spin-on composition” and “spin-on inorganic composition” (where the composition is substantially inorganic) may be used interchangeable and refer to those solutions and compositions that can be spun-on to a substrate or surface. It is further contemplated that the phrase “spin-on-glass materials” refers to a subset of “spin-on inorganic materials”, in that spin-on glass materials refer to those spin-on materials that comprise silicon-based compounds and/or polymers in whole or in part. Examples of silicon-based compounds comprise siloxane compounds, such as methylsiloxane, methylsilsesquioxane, phenylsiloxane, phenylsilsesquioxane, methylphenylsiloxane, methylphenylsilsesquioxane, silazane polymers, silicate polymers and mixtures thereof. A contemplated silazane polymer is perhydrosilazane, which has a “transparent” polymer backbone where chromophores can be attached. An example of a spin-on glass composition is NANOGLASS™ E —a nanoporous silicon-based composition manufactured by Honeywell Electronic Materials. SiLK™ manufactured by Dow is another example of a porous silicon-based dielectric material that would be appropriate to use as a spin-on dielectric material.

As used herein, the phrase “spin-on-glass materials” also includes siloxane polymers and blockpolymers, hydrogensiloxane polymers of the general formula (H_{0-1.0}-OSiO_{1.5-2.0})ₓ and hydrogensilsesquioxane polymers, which have the formula (HSiO_{1.5})ₓ, where x is greater than about four. Also included are copolymers of hydrogensilsesquioxane and an alkoxyhydridosiloxane or hydroxyhydridosiloxane. Spin-on glass materials additionally include organohydridosiloxane polymers of the general formula (H_{0-1.0}OSiO_{1.5-2.0})ₙ(R_{0-1.0}SiO_{1.5-2.0})ₘ, and organohydridosilsesquioxane polymers of the general formula (HSiO_{1.5})ₙ(RSiO_{1.5})ₘ, where m is greater than zero and the sum of n and m is greater than about four and R is alkyl or aryl. Some useful organohydridosiloxane polymers have the sum of n and m from about four to about 5000 where R is a C₁-C₂₀ alkyl group or a C₆-C₁₂ aryl group. The organohydridosiloxane and organohydridosilsesquioxane polymers are alternatively denoted spin-on-polymers. Some specific examples include alkylhydridosiloxanes, such as methylhydridosiloxanes, ethylhydridosiloxanes, propylhydridosiloxanes, t-butylhydridosiloxanes, phenylhydridosiloxanes; and alkylhydridosilsesquioxanes, such as methylhydridosilsesquioxanes, ethylhydridosilsesquioxanes, propylhydridosilsesquioxanes, t-butylhydridosilsequioxanes, phenylhydridosilsesquioxanes, and combinations thereof. Several of the contemplated spin-on materials are described in the following issued patents and pending applications, which are herein incorporated by reference in their entirety: (PCT/US00/15772 filed Jun. 8, 2000; U.S. application Ser. No. 09/330,248 filed Jun. 10, 1999; U.S. application Ser. No. 09/491,166 filed Jun. 10, 1999; U.S. Pat. No. 6,365,765 issued on Apr. 2, 2002; U.S. Pat. No. 6,268,457 issued on Jul. 31, 2001; U.S. application Ser. No. 10/001,143 filed Nov. 10, 2001; U.S. application Ser. No. 09/491,166 filed Jan. 26, 2000; PCT/US00/00523 filed Jan. 7, 1999; U.S. Pat. No. 6,177,199 issued Jan. 23, 2001; U.S. Pat. No. 6,358,559 issued Mar. 19, 2002; U.S. Pat. No. 6,218,020 issued Apr. 17, 2001; U.S. Pat. No. 6,361,820 issued Mar. 26, 2002; U.S. Pat. No. 6,218,497 issued Apr. 17, 2001; U.S. Pat. No. 6,359,099 issued Mar. 19, 2002; U.S. Pat. No. 6,143,855 issued Nov. 7, 2000; and U.S. application Ser. No. 09/611,528 filed March 20, 1998).

Solutions of organohydridosiloxane and organosiloxane resins can be utilized for forming caged siloxane polymer films that are useful in the fabrication of a variety of electronic devices, micro-electronic devices, particularly semiconductor integrated circuits and various layered materials for electronic and semiconductor components, including hardmask layers, dielectric layers, etch stop layers and buried etch stop layers contemplated herein. These organohydridosiloxane resin layers are quite compatible with other materials that might be used for layered materials and devices, such as adamantane-based compounds, diamantane-based compounds, silicon-core compounds, organic dielectrics, and nanoporous dielectrics. Compounds that are considerably compatible with the organohydridosiloxane resin layers contemplated herein are disclosed in PCT Application PCT/US01/32569 filed Oct. 17, 2001; PCT Application PCT/US01/50812 filed Dec. 31, 2001; U.S. application Ser. No. 09/538,276; U.S. application Ser. No. 09/544,504; U.S. application Ser. No. 09/587,851; U.S. Pat. No. 6,214,746; U.S. Pat. No. 6,171,687; U.S. Pat. No. 6,172,128; U.S. Pat. No. 6,156,812, U.S. Application Serial No. 60/350,187 filed Jan. 15, 2002; and U.S. 60/347,195 filed Jan. 8, 2002, which are all incorporated herein by reference in their entirety.

Organohydridosiloxane resins utilized herein have the following general formulas:

[H-Si_{1.5}]ₙ[R-SiO_{1.5}]ₘ Formula (1)

[H_{0.5}-Si_{1.5-1.8}.]ₙ[R_{0.5-1.0}-SiO_{1.5-1.8}]ₘ Formula (2)

[H_{0-1.0}-Si_{1.5}]ₙ[R-SiO_{1.5}]ₘ Formula (3)

[H-Si_{1.5}]ₓ[R-SiO_{1.5}]_{y}[SiO₂]_{z} Formula (4)

wherein:

the sum of n and m, or the sum or x, y and z is from about 8 to about 5000, and m or y is selected such that carbon containing constituents are present in either an amount of less than about 40 percent (Low Organic Content=LOSP) or in an amount greater than about 40 percent (High Organic Content=HOSP); R is selected from substituted and unsubstituted, normal and branched alkyls (methyl, ethyl, butyl, propyl, pentyl), alkenyl groups (vinyl, allyl, isopropenyl), cycloalkyls, cycloalkenyl groups, aryls (phenyl groups, benzyl groups, naphthalenyl groups, anthracenyl groups and phenanthrenyl groups), and mixtures thereof; and wherein the specific mole percent of carbon containing substituents is a function of the ratio of the amounts of starting materials. In some LOSP embodiments, particularly favorable results are obtained with the mole percent of carbon containing substituents being in the range of between about 15 mole percent to about 25 mole percent. In some HOSP embodiments, favorable results are obtained with the mole percent of carbon containing substituents are in the range of between about 55 mole percent to about 75 mole percent.

Nanoporous silica dielectric films with dielectric constants ranging from 1.5 to about 3.8 can be also as at least one of the spin-on layers. Nanoporous silica compounds contemplated herein are those compounds found in U.S. Pat. Nos. 6,022,812; 6,037,275; 6,042,994; 6,048,804; 6,090,448; 6,126,733; 6,140,254; 6,204,202; 6,208,041; 6,318,124 and 6,3119,855. These types of films are laid down as a silicon-based precursor, aged or condensed in the presence of water and heated sufficiently to remove substantially all of the porogen and to form voids in the film. The silicon-based precursor composition comprises monomers or prepolymers that have the formula: Rₓ—Si—L_{y}, wherein R is independently selected from alkyl groups, aryl groups, hydrogen and combinations thereof, L is an electronegative moiety, such as alkoxy, carboxy, amino, amido, halide, isocyanato and combinations thereof, x is an integer ranging from 0 to about 2, and y is an integer ranging from about 2 to about 4.

The phrases “cage structure”, “cage molecule”, and “cage compound” are intended to be used interchangeably and refer to a molecule having at least 10 atoms arranged such that at least one bridge covalently connects two or more atoms of a ring system. In other words, a cage structure, cage molecule or cage compound comprises a plurality of rings formed by covalently bound atoms, wherein the structure, molecule or compound defines a volume, such that a point located with the volume can not leave the volume without passing through the ring. The bridge and/or the ring system may comprise one or more heteroatoms, and may be aromatic, partially saturated, or unsaturated. Further contemplated cage structures include fullerenes, and crown ethers having at least one bridge. For example, an adamantane or diamantane is considered a cage structure, while a naphthalene or an aromatic spirocompound are not considered a cage structure under the scope of this definition, because a naphthalene or an aromatic spirocompound do not have one, or more than one bridge.

Contemplated cage compounds need not necessarily be limited to being comprised solely of carbon atoms, but may also include heteroatoms such as N, S, O, P, etc. Heteroatoms may advantageously introduce non-tetragonal bond angle configurations. With respect to substituents and derivatizations of contemplated cage compounds, it should be recognized that many substituents and derivatizations are appropriate. For example, where the cage compounds are relatively hydrophobic, hydrophilic substituents may be introduced to increase solubility in hydrophilic solvents, or vice versa. Alternatively, in cases where polarity is desired, polar side groups may be added to the cage compound. It is further contemplated that appropriate substituents may also include thermolabile groups, nucleophilic and electrophilic groups. It should also be appreciated that functional groups may be employed in the cage compound (e.g., to facilitate crosslinking reactions, derivatization reactions, etc.) Where the cage compounds are derivatized, it is especially contemplated that derivatizations include halogenation of the cage compound, and a particularly preferred halogen is fluorine.

Cage molecules or compounds, as described in detail herein, can also be groups that are attached to a polymer backbone, and therefore, can form nanoporous materials where the cage compound forms one type of void (intramolecular) and where the crosslinking of at least one part of the backbone with itself or another backbone can form another type of void (intermolecular). Additional cage molecules, cage compounds and variations of these molecules and compounds are described in detail in PCT/US01/32569 filed on Oct. 18, 2001, which is herein incorporated by reference in its entirety.

Contemplated polymers may also comprise a wide range of functional or structural moieties, including aromatic systems, and halogenated groups. Furthermore, appropriate polymers may have many configurations, including a homopolymer, and a heteropolymer. Moreover, alternative polymers may have various forms, such as linear, branched, super-branched, or three-dimensional. The molecular weight of contemplated polymers spans a wide range, typically between 400 Dalton and 400000 Dalton or more.

The organic and inorganic materials described herein are similar in some respects to those which are described in U.S. Pat. No. 5,874,516 to Burgoyne et al. (February 1999), incorporated herein by reference, and may be used in substantially the same manner as set forth in that patent. For example, it is contemplated that the organic and inorganic materials described herein may be employed in fabricating electronic chips, chips, and multichip modules, interlayer dielectrics, protective coatings, and as a substrate in circuit boards or printed wiring boards. Moreover, films or coatings of the organic and inorganic materials described herein can be formed by solution techniques such as spraying, spin coating or casting, with spin coating being preferred. Preferred solvents are 2-ethoxyethyl ether, cyclohexanone, cyclopentanone, toluene, xylene, chlorobenzene, N-methylpyrrolidinone, N,N-dimethylformamide, N,N-dimethylacetamide, methyl isobutyl ketone, 2-methoxyethyl ether, 5-methyl-2-hexanone, γ-butyrolactone, and mixtures thereof. Typically, the coating thickness is between about 0.1 to about 15 microns. As a dielectric interlayer, the film thickness is less than 2 microns. Additives can also be used to enhance or impart particular target properties, as is conventionally known in the polymer art, including stabilizers, flame retardants, pigments, plasticizers, surfactants, and the like. Compatible or non-compatible polymers can be blended in to give a desired property. Adhesion promoters can also be used. Such promoters are typified by hexamethyldisilazane, which can be used to interact with available hydroxyl functionality that may be present on a surface, such as silicon dioxide, that was exposed to moisture or humidity. Polymers for microelectronic applications desirably contain low levels (generally less than 1 ppm, preferably less than 10 ppb) of ionic impurities, particularly for dielectric interlayers.

As used herein, the term “crosslinking” refers to a process in which at least two molecules, or two portions of a long molecule, are joined together by a chemical interaction. Such interactions may occur in many different ways including formation of a covalent bond, formation of hydrogen bonds, hydrophobic, hydrophilic, ionic or electrostatic interaction. Furthermore, molecular interaction may also be characterized by an at least temporary physical connection between a molecule and itself or between two or more molecules.

As mentioned earlier, some preferred embodiments comprise a plurality of voids in one or all of the spin-on dielectric layers or spin-on low dielectric constant layers. This plurality of voids can also be expressed by using the phrase “nanoporous layer”. As used herein, the term “nanoporous layer” refers to any suitable low dielectric material (i.e. <3.0) that is composed of a plurality of voids and a non-volatile component. As used herein, the term “substantially” means a desired component is present in a layer at a weight percent amount greater than 51%.

As used herein, the word “void” means a volume in which mass is replaced with a gas. The composition of the gas is generally not critical, and appropriate gases include relatively pure gases and mixtures thereof, including air. It is contemplated that any one of the spin-on layers may comprise a plurality of voids. Voids may have any suitable shape. Voids are typically spherical, but may alternatively or additionally have tubular, lamellar, discoidal, or other shapes. It is also contemplated that voids may have any appropriate diameter. It is further contemplated that voids have some connections with adjacent voids to create a structure with a significant amount of connected or “open” porosity. In preferred embodiments, voids have a mean diameter of less than 1 micrometer. In more preferred embodiments, voids have a mean diameter of less than 100 nanometers. And in still more preferred embodiments, voids have a mean diameter of less than 10 nanometers. It is further contemplated that voids may be uniformly or randomly dispersed within any one of the spin-on layers. In a preferred embodiment, voids are uniformly dispersed within any of the spin-on layers.

The materials and layers described herein can be and in many ways are designed to be solvated or dissolved in any suitable solvent, so long as the resulting solutions can be spun on to a substrate, a surface, a wafer or layered material. Typical solvents are also those solvents that are able to solvate the monomers, isomeric monomer mixtures and polymers. Contemplated solvents include any suitable pure or mixture of organic, organometallic or inorganic molecules that are volatilized at a desired temperature, such as the critical temperature. The solvent may also comprise any suitable pure or mixture of polar and non-polar compounds. In preferred embodiments, the solvent comprises water, ethanol, propanol, acetone, ethylene oxide, benzene, toluene, ethers, cyclohexanone, butyrolactone, methylethylketone, and anisole. In the preferred embodiments, no solvent is used and at least one liquid monomer is chosen to form a solventless formulation.

As used herein, the term “pure” means that component that has a constant composition. For example, pure water is composed solely of H₂O. As used herein, the term “mixture” means that component that is not pure, including salt water. As used herein, the term “polar” means that characteristic of a molecule or compound that creates an unequal charge distribution at one point of or along the molecule or compound. As used herein, the term “non-polar” means that characteristic of a molecule or compound that creates an equal charge distribution at one point of or along the molecule or compound.

It is still further contemplated that alternative low dielectric constant material may also comprise additional components. For example, where the low dielectric constant material is exposed to mechanical stress, softeners or other protective agents may be added. In other cases where the dielectric material is placed on a smooth surface, adhesion promoters may advantageously employed. In still other cases, the addition of detergents or antifoam agents may be desirable.

At least one spin-on low dielectric constant layer is coupled to the at least one spin-on dielectric layer. Any of the materials already described herein can be used to form the additional spin-on low dielectric constant layer. It is especially important to understand that the material used for the dielectric layer that is coupled to the surface can be completely different from the at least one spin-on low dielectric constant layer. For example, the first spin-on layer may comprise an organic cage-based compound, such as GX-3™ (an adamantane-based compound) and a second spin-on layer may comprise an organosiloxane or organohydridosiloxane compound, such as HOSP™ (an organosiloxane polymer). In another example, the first spin-on layer may comprise an organosiloxane compound, the second spin-on layer may comprise an adamantane-based compound, the third spin-on layer may comprise another organosiloxane compound and a fourth layer may comprise a spin-on glass material, such as NANOGLASS E™. As mentioned earlier, several of the contemplated compounds are shown in Table 1, along with many of their measurable physical properties. Film properties of GX-3 are also shown in Table 2. Additional properties of some of the materials produced by Honeywell Electronic Materials are shown in Table 3.

Once the at least one spin-on dielectric layer is coupled to the surface, an effective dielectric constant can be measured for the stack that comprises the surface and the layer. The effective dielectric constant (k_{eff}) should remain the same or be slightly lowered with each additional spin-on low dielectric constant layer. In preferred embodiments, the effective dielectric constant will be lowered with each additional spin-on low dielectric constant layer. In preferred embodiments, the effective dielectric constant of the layered component will be less than 3.0. In more preferred embodiments, the effective dielectric constant of the layered component will be less than 2.5.

Additional spin-on low dielectric constant layers may comprise layers such as etch-stop layers, cap layers, hardmask layers and the like. It is contemplated that these additional spin-on low dielectric constant layers will have an effective dielectric constant of less than 3.0. It is more contemplated that any additional spin-on low dielectric constant layers will have an effective dielectric constant of less than 2.5.

At least one supplementary layer of material may be added to the layered stack or layered component. A supplementary layer of material is that layer of material or materials that is designed to add to the low dielectric constant layered component, but doesn't necessarily have to be spun-on to the layered component. Examples of supplementary layers of materials comprise metals (such as those which might be used to form via fills or printed circuits and also those included in U.S. Pat. Nos. 5,780,755; 6,113,781; 6,348,139 and 6,332,233 all of which are incorporated herein in their entirety), metal diffusion layers, mask layers, anti-reflective coatings layers, adhesion promoter layers and the like.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include titanium, silicon, cobalt, copper, nickel, zinc, vanadium, aluminum, chromium, platinum, gold, silver, tungsten, molybdenum, cerium, promethium, and thorium. More preferred metals include titanium, silicon, copper, nickel, platinum, gold, silver and tungsten. Most preferred metals include titanium, silicon, copper and nickel. The term “metal” also includes alloys, metal/metal composites, metal ceramic composites, metal polymer composites, as well as other metal composites.

A layer of laminating material or cladding material may also be considered a supplementary layer of material and may be coupled to the layered component depending on the specifications required by the component. Laminates are generally considered fiber-reinforced resin dielectric materials. Cladding materials are a subset of laminates that are produced when metals and other materials, such as copper, are incorporated into the laminates. (Harper, Charles A., Electronic Packaging and Interconnection Handbook, Second Edition, McGraw-Hill (New York), 1997.)

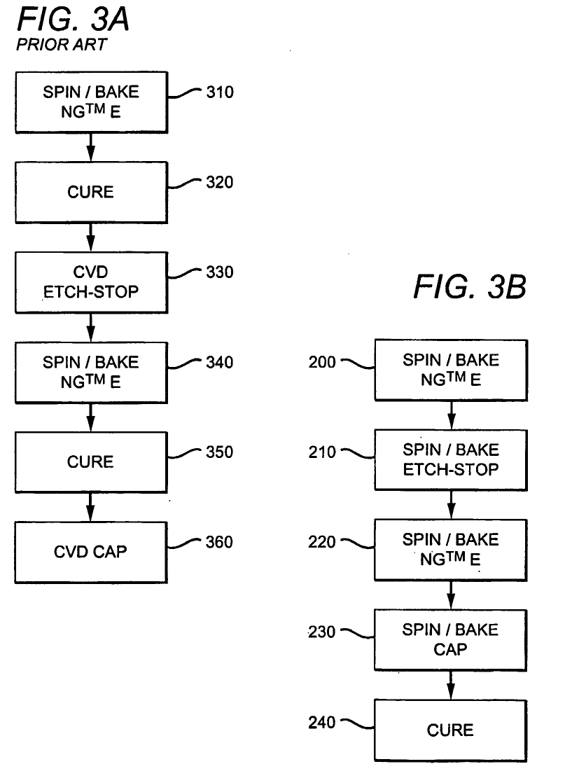

As generally shown in FIG. 3B, a method of producing a low dielectric constant layered component comprises: a) providing a surface; b) spinning a dielectric material on to the surface; c) curing the dielectric material to form a dielectric layer; d) spinning a low dielectric constant material on to the dielectric layer; and e) curing the low dielectric constant material to form a low dielectric constant layer. Specifically, in FIG. 3B—which is a preferred embodiment—a NANOGLASS™ E layer is spun on to a surface and baked (200); an etch-stop layer is spun onto the NANOGLASS™ E layer and baked (210); another NANOGLASS™ E layer is spun-on and baked (220); a cap layer is spun on to the NANOGLASS™ E layer and baked (230) and finally, the layered stack or layered component is cured (240). In one preferred embodiment, each layer is cured subsequent to its deposition. In another preferred embodiment, which is shown in FIG. 3B, each layer is spun-on to the layered component and then the entire stack is cured at one time. Also shown in Prior Art FIG. 3A, is the conventional method of producing a layered component. Specifically, Prior Art FIG. 3A shows a NANOGLASS™ E layer is spun-on to a surface and baked (310); the NANOGLASS™ E layer is then cured (320); a CVD etch stop layer is added to the NANOGLASS™ E layer (330); another NANOGLASS™ E layer is spun-on to the CVD-applied layer and baked (340); the NANOGLASS™ E layer is cured (350); and a CVD-applied cap is added (360) to the layered stack or component.

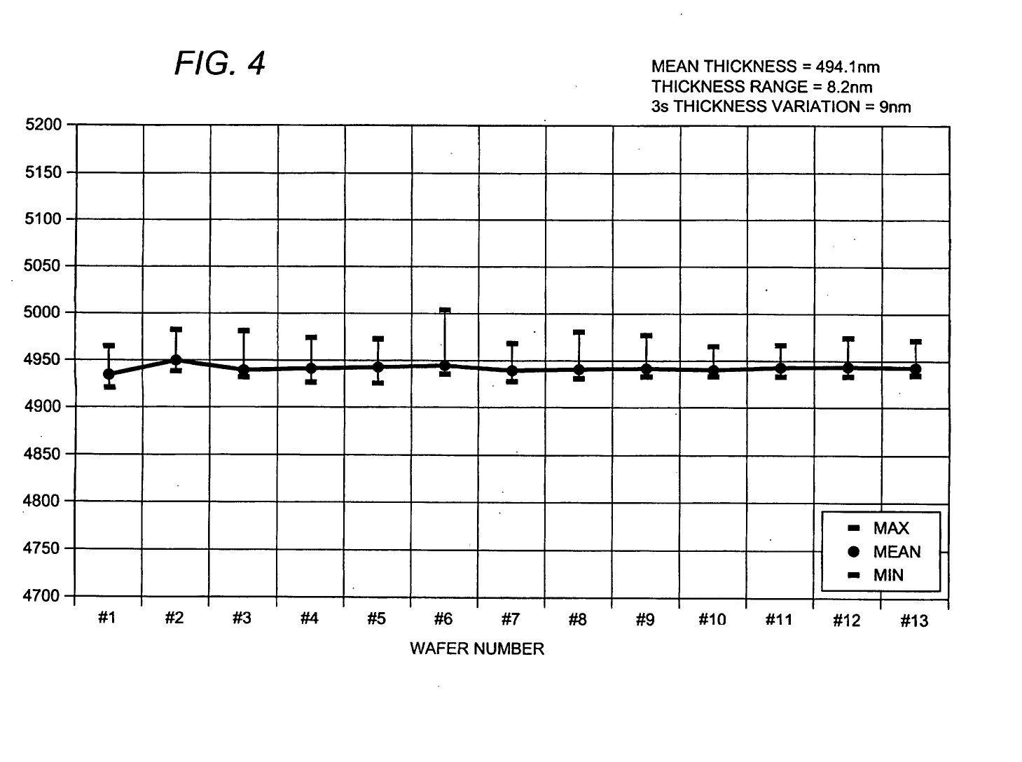

Any suitable coating mechanism or apparatus may be used to apply the spin-on layers and materials. Examples of a suitable coating apparatus include an FSI 300 mm coater or a TEL ACT 12 Coater. Suitable coating mechanisms or apparatus should be able to a) reliably dispense spin-on materials at reproducible thicknesses; b) reliably dispense several different types of spin-on materials; c) easily integratable into an existing manufacturing process; and d) easy to use and operate. FIG. 4 shows a graph of typical wafer-to-wafer spin-on uniformity measurements for FLARE™ (polyarylene ether) coatings using a TEL ACT 12 Coater.

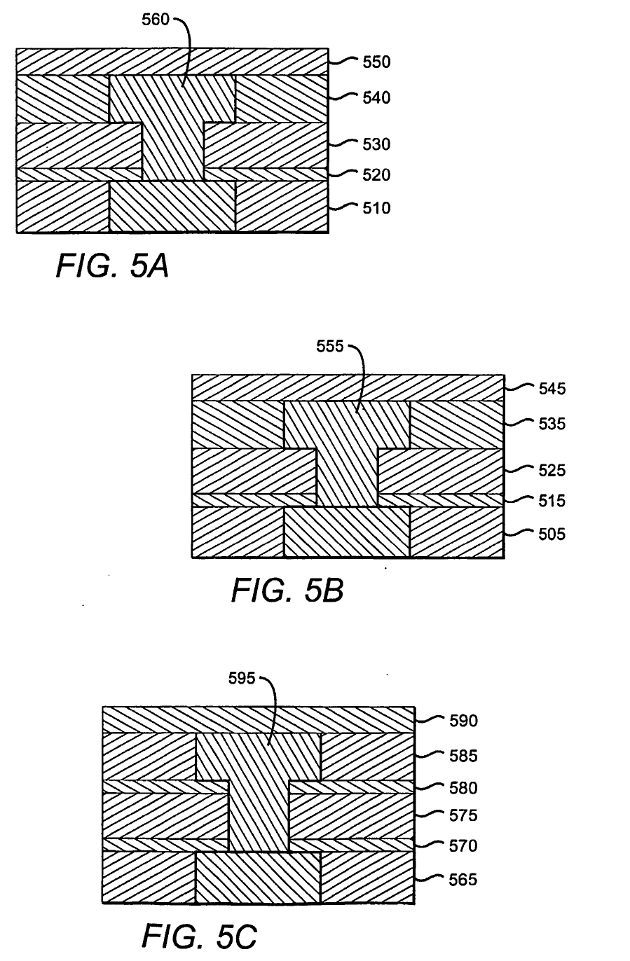

FIG. 5 shows several embodiments of the present invention. FIG. 5A shows a layered component comprising a layer of GX-3™ (510) coupled to a spin-on barrier/etch stop layer (520), which is coupled to a layer of ELK-HOSP™ or NANOGLASS™ E (530), which is coupled to a layer of GX-3™ (540), which is capped off by a spin-on cap layer (550). Copper is used as the via fill (560) for this particular layered stack. FIG. 5B shows a layered component comprising a layer of ELK-HOSP™ or NANOGLASS™ E (505) coupled to a spin-on barrier/etch stop layer (515), which is coupled to a layer of GX-3™ (525), which is coupled to a layer of ELK-HOSP™ or NANOGLASS™ E (535), which is capped off by a spin-on cap layer (545). Copper is used as the via fill (555) for this particular layered stack. FIG. 5C shows a layered component comprising a layer of GX-3™ (565) coupled to a spin-on copper barrier layer (570), which is coupled to a layer of GX-3™ (575), which is coupled to a layer of ELK-HOSP™ or NANOGLASS™ E (580), which is coupled to a layer of GX-3™ (585), which is capped off by a spin-on cap layer of ELK-HOSP™ or NANOGLASS™ E (590). Copper is used as the via fill (595) for this particular layered stack.

Components, electronic components, and semiconductor components, as contemplated herein, are generally thought to comprise any single or layered component that can be utilized in an electronic-based product. The phrase “layered electronic stack” can be used interchangeably with the phrase “electronic component”, “layered component” or “layered stack” when the electronic component is a layered component. Contemplated electronic components comprise circuit boards, chip packaging, dielectric components of circuit boards, printed-wiring boards, and other components of circuit boards, such as capacitors, inductors, and resistors.

As used herein, the term “electronic component” also means any device or part that can be used in a circuit to obtain some desired electrical action. Electronic components contemplated herein may be classified in many different ways, including classification into active components and passive components. Active components are electronic components capable of some dynamic function, such as amplification, oscillation, or signal control, which usually requires a power source for its operation. Examples are bipolar transistors, field-effect transistors, and integrated circuits. Passive components are electronic components that are basically static in operation, i.e., are ordinarily incapable of amplification or oscillation, and usually require no power for their characteristic operation. Examples are conventional resistors, capacitors, inductors, diodes, rectifiers and fuses.

Electronic components contemplated herein may also be classified as conductors, semiconductors, or insulators. Here, conductors are components that allow charge carriers (such as electrons) to move with ease among atoms as in an electric current. Examples of conductor components are circuit traces and vias comprising metals. Insulators are components where the function is substantially related to the ability of a material to be extremely resistant to conduction of current, such as a material employed to electrically separate other components, while semiconductors are components having a function that is substantially related to the ability of a material to conduct current with a natural resistivity between conductors and insulators. Examples of semiconductor components are transistors, diodes, some lasers, rectifiers, thyristors and photosensors.

Electronic components contemplated herein may also be classified as power sources or power consumers. Power source components are typically used to power other components, and include batteries, capacitors, coils, and fuel cells. Power consuming components include resistors, transistors, ICs, sensors, and the like.

Still further, electronic components contemplated herein may also be classified as discreet or integrated. Discreet components are devices that offer one particular electrical property concentrated at one place in a circuit. Examples are resistors, capacitors, diodes, and transistors. Integrated components are combinations of components that that can provide multiple electrical properties at one place in a circuit. Examples are ICs, i.e., integrated circuits in which multiple components and connecting traces are combined to perform multiple or complex functions such as logic.

As used herein the various forms of the terms “layered” or “multilayered”, as applied to components, means that the functionality of the component arises from having juxtaposed layers of different materials. For example, a typical P-N-P transistor is considered herein to be a multilayered component because its functions arise from the juxtaposition of P and N doped semiconductor layers. On the other hand, a conductive trace on a circuit board would not generally be considered to be multilayered by itself, even if the trace had been manufactured by successive deposits of the conductive material, because each successive layer merely increases the current carrying capacity, rather than altering the functionality of the trace.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up mock-up. A prototype may or may not contain all of the actual components intended in a finished product, and a prototype may have some components that are constructed out of composite material in order to negate their initial effects on other components while being initially tested.

Electronic products and components may comprise layered materials, layered components, and components that are laminated in preparation for use in the component or product. Layers that include or comprise electronic components can make up the finished layered component or product.

### EXAMPLES

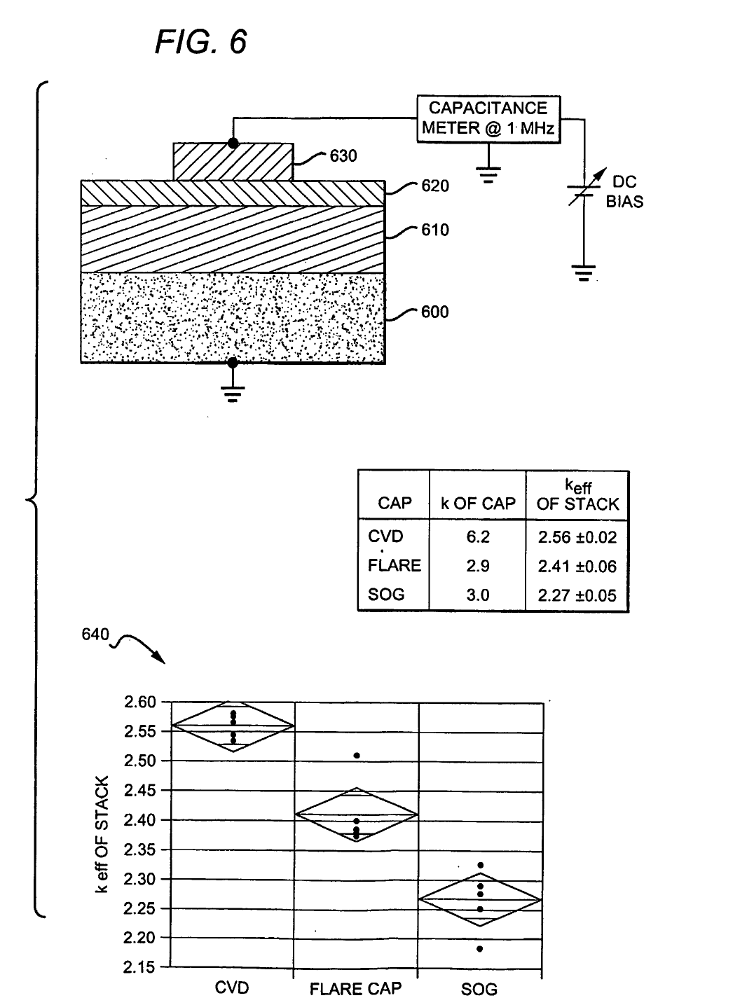

FIG. 6 shows the effective dielectric constant measured for a Two-layered stack comprising a silicon layer (600), a spin-on layer of NANOGLASS™ E (610), a spin-on cap layer (620), and a layer of aluminum (630). Graph 640 shows the effective dielectric constant of three different cap layers (620): CVD, FLARE™, and NANOGLASS™ E.

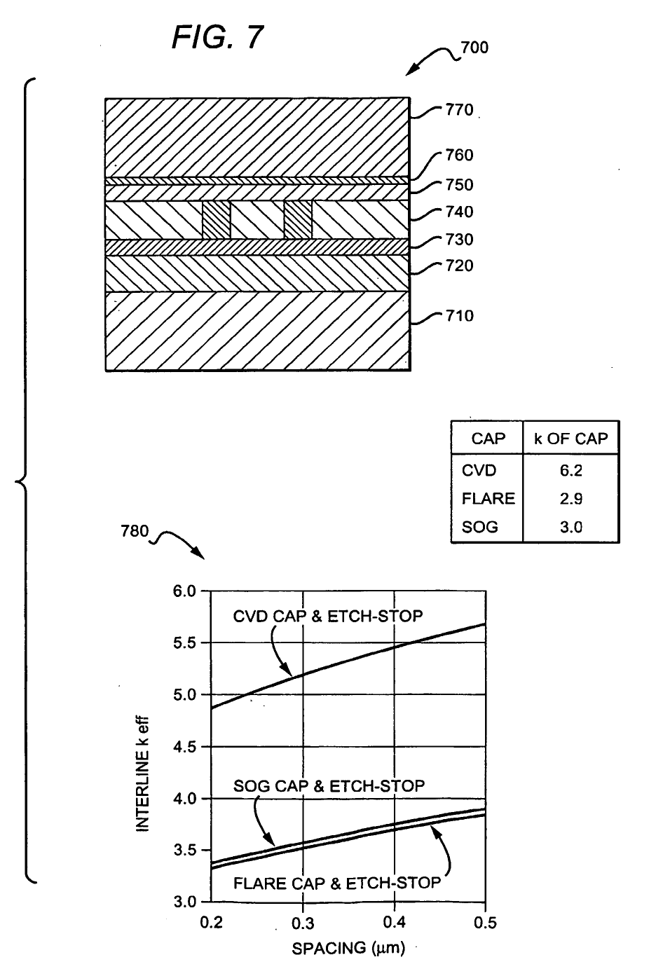

FIG. 7 shows an Interline effective dielectric constant measurement for a Dual Damascene process. The layered stack (700) comprises a CVD barrier (710), a spin-on layer of NANOGLASS™ E (720), a spin-on etch stop layer (730), another spin-on layer of NANOGLASS™ E (740), a spin-on cap layer (750), a spin-on CVD barrier (760), and another spin-on NANOGLASS™ E layer (770). The etch stop layer and cap layer comprise CVD, FLARE™, and NANOGLASS™ E for the purposes of measurement of the Interline effective dielectric constant, shown in graph 780.

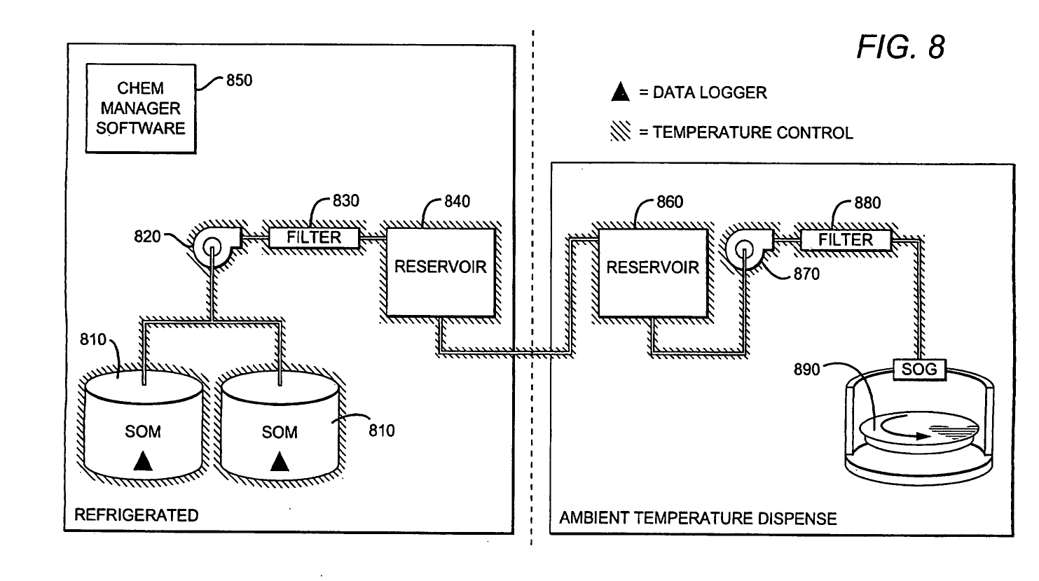

FIG. 8 shows a schematic of a Spin-on Dielectric Bulk Delivery System for Manufacturing. A spin-on material (SOM) (810) is directed through a pump (820), a filter (830) and into a reservoir (830). This first process (840) is refrigerated and directed by Chem. Managing Software (850). The SOM (810) is sent from the reservoir (830) into another reservoir (860), where the SOM (810) is directed through a second pump (870), a second filter (880) and on to the surface (890) by a spin-on process.

Thus, specific embodiments and applications of compositions and methods to produce low dielectric constant layered materials and components comprising those materials have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

TABLE 1

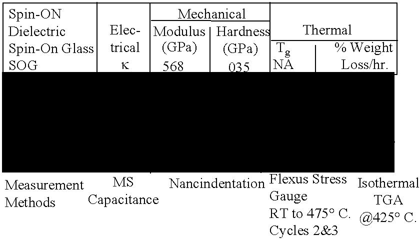

TABLE 2
GX-3 Dielectric Film Properties

| | GX-3 | | GX-3P | Low k Film |
|---|---|---|---|---|
| Film Property | Experimental | | Experimental | Requirements |
| Cure | 400° | C./60 min | 350-400° C./ | |
| Condition | | | 60 min | |
| (furnace | | | 400-425° C./ | |
| cure in N₂) | | | 30 min | |
| Thickness | 0.1, 0.4, 0.6, | | 0.3, 0.6 | 0.2-1.5 |
| (μm) | 1.0, 1.6 | | | |
| n_{baked} | 1.665 | | 1.59-1.61 | |
| (@ 633 nm) | | | | |
| n_{cured} | 1.60 | | 1.39-1.53 | |
| (@ 633 nm) | | | | |
| K(@ 1 MHz) | | | | |
| pre-bake | 2.75 | | | |
| post-bake | 2.68 | | 2.32 | 1.90 |
| Tg (2 cycle: | | | | |
| RT − 475° C.) | | | | |
| 1^{st} cycle | 400 | | | >400 |
| 2^{nd} cycle | >475 | | | |
| E_{mod} | 6.40 | GPa (1.6 μm) | | >6 GPa |
| | 7.12 | GPa (1.0 μm) | | |
| | 8.76 | GPa (0.6 μm) | | |
| Hardness | 0.65 | GPa (1.6 μm) | | TBD |
| | 0.72 | GPa (1.0 μm) | | |
| | 0.83 | GPa (0.6 μm) | | |

| | | |
|---|---|---|
| ITGA | 1.95 | <1% wt loss |
| (% loss @ | | no outgassing |
| 425 C.) | | |

TABLE 3

| | FLARE ® | GX-3 | GX-3P | HOSP | NG E |
|---|---|---|---|---|---|
| Material Type - Base Backbone | Organic/Solid | Organic/Solid | Organic/Porous | Inorganic/Solid | Inorganic/Porous |
| Electrical Properties | | | | | |
| Dielectric Constant | 2.85 | 2.6 | 2.3 | 2.5 | 2.2 |
| Breakdown Voltage, MV/cm | >2 | >2 | TBD | >2 | >2 |
| Thermal Properties | | | | | |
| Shrinkage, %, 400 C/10 hr | 1.24 | 1 | 1 | No discernable | <1 |
| | | | | change | |
| Shrinkage, %, 425 C/10 hr | 4 | 2 | 2 | No discernable | 2 |
| | | | | change | |
| ITGA % Wt Loss @ 425 C per hour | 0.8 | 0.38 | TBD | <1.0 | <1.0 |
| Mechanical Properties | | | | | |
| Tg, ° C. | 400 | >450 | TBD | No Tg | No Tg |
| Modulus, GPa | 4.8-5.1 | 6.3-7.1 | 6.3 (0.4 um) | 3.4-4.4 | 5.8-6.2 |
| Hardness, GPa | 0.35-0.4 | 0.79-0.84 | 0.50 (0.4 um) | 0.37-0.43 | 0.7-0.9 |
| Residual Stress in film after cure (MPa) | | | | 40 | 20 |
| Stud Pull Strength, kpsi | >11 | 11 | 11 | | |
| Tape Test | pass | pass | pass | pass | pass |
| Other Properties | | | | | |
| Refractive Index (633 nm) | 1.675 | 1.627 | 1.39-1.53 | 1.36 | 1.265 |
| Compatible with Solvents | Yes | Yes | Yes | Yes | Yes |

We claim:

1. A low dielectric constant layered component, comprising:
a surface;
at least one spin-on dielectric layer coupled to the surface;
at least one spin-on low dielectric constant stop layer coupled to the at least one spin-on dielectric layer; and
at least one additional spin on low dielectric constant layer coupled to the at least one spin-on low dielectric constant stop layer.

2. The low dielectric constant layered component of claim 1, wherein the at least one additional spin-on low dielectric constant layer comprises at least one spin-on barrier layer.

3. The low dielectric constant layered component of claim 1, wherein the at least one additional spin-on low dielectric constant layer comprises at least one spin-on cap layer.

4. The low dielectric constant layered component of claim 1, wherein the at least one additional spin-on low dielectric constant layer comprises two or more layers.

5. The low dielectric constant layered component of claim 1, wherein the at least one spin-on dielectric layer, the at least one spin-on low dielectric constant stop layer, or the at least one additional spin-on low dielectric constant layer comprises a dielectric constant less than 3.0.

6. The low dielectric constant layered component of claim 5, wherein the at least one spin-on dielectric layer, the at least one spin-on low dielectric constant stop layer, or the at least one additional one spin-on low dielectric constant layer comprises a dielectric constant less than 2.5.

7. The low dielectric constant layered component of claim 1, wherein the layered material has an effective dielectric constant of less than 3.0.

8. The low dielectric constant layered component of claim 1, wherein the layered material has an effective dielectric constant of less than 2.5.

9. The low dielectric constant layered component of claim 1, wherein the at least one spin-on dielectric layer, the at least one spin-on low dielectric constant stop layer, or the at least one additional spin-on low dielectric constant layer comprises at least one organic compound.

10. The low dielectric constant layered component of claim 9, wherein the at least one organic compound comprises a cage-based compound.

11. The low dielectric constant layered component of claim 10, wherein the cage-based compound comprises an adamantane-based molecule.

12. The low dielectric constant layered component of claim 9, wherein the at least one organic compound comprises a polymer-based compound.

13. The low dielectric constant layered component of claim 12, wherein the polymer-based compound comprises polyarylene ether.

14. The low dielectric constant layered component of claim 1, wherein the at least one spin-on dielectric layer, the at least one spin-on low dielectric constant stop layer, or the at least one additional spin-on low dielectric constant layer comprises at least one inorganic compound.

15. The low dielectric constant layered component of claim 14, wherein the at least one inorganic compound comprises at least one silicon atom.

16. The low dielectric constant layered component of claim 14, wherein the at least one inorganic compound comprises an organosiloxane compound.

17. The low dielectric constant layered component of claim 14, wherein the at least one inorganic compound comprises a hydridosiloxane compound.

18. The low dielectric constant layered component of claim 1, wherein the at least one spin-on dielectric layer, the at least one spin-on low dielectric constant stop layer, or the at least one additional spin-on low dielectric constant layer comprises a plurality of voids.

19. The low dielectric constant layered component of claim 1, further comprising at least one supplementary layer of material.

20. The low dielectric constant layered component of claim 19, wherein the at least one supplementary layer of material comprises a metal-diffusion layer.

21. The low dielectric constant layered component of claim 19, wherein the at least one supplementary layer of material comprises a metal layer.

22. The low dielectric constant layered component of claim 19, wherein the at least one supplementary layer of material comprises an adhesion promoter layer.

23. A method of forming a low dielectric constant layered component, comprising:
providing a surface;
spinning a dielectric material on to the surface;
curing the dielectric material to form a dielectric layer;
spinning a low dielectric constant material on to the dielectric layer, wherein the layered stack comprises at least one spin-on stop layer; and
curing the low dielectric constant material to form a low dielectric constant layer.

24. The method of claim 23, wherein the dielectric material and the low dielectric constant material comprise a dielectric constant less than 3.0.

25. The method of claim 23, wherein the dielectric material and the low dielectric constant material comprise a dielectric constant less than 2.5.

26. A method of forming a low dielectric constant layered component, comprising:
providing a surface;
spinning a dielectric material on to the surface;
spinning a low dielectric constant material on to the dielectric layer to form a layered stack, wherein the layered stack comprises at least one spin-on stop layer; and
curing the layered stack to form a low dielectric constant layered component.

27. The method of claim 23, wherein curing the dielectric material and curing the low dielectric constant material comprises using an extended curing source.

28. The method of claim 27, wherein the extended curing source comprises a heat source.

29. The method of claim 23, wherein curing the dielectric material and curing the low dielectric constant material comprises forming a plurality of voids.

30. A layered component produced by the method of claim 23.

31. A layered component produced by the method of claim 26.
